(19) United States
(12) Patent Application Publication
(10) Pub. No.: US 2026/0194456 A1
(43) Pub. Date: Jul. 9, 2026

(54) DETECTION DEVICE

(71) Applicant: Japan Display Inc., Tokyo (JP)

(72) Inventors: Kaoru ITO, Tokyo (JP); Akihiko FUJISAWA, Tokyo (JP); Daichi ABE, Tokyo (JP); Norio MAMBA, Tokyo (JP)

(21) Appl. No.: 19/429,201

(22) Filed: Dec. 22, 2025

(30) Foreign Application Priority Data
Jan. 6, 2025 (JP) 2025-001825

(51) Int. Cl. G01N 21/27; G01N 21/25

(52) U.S. Cl. CPC G01N 21/274; G01N 21/255

(57) ABSTRACT

According to an aspect, a detection device includes: a sensor panel having a plurality of optical sensors; a light source; and a control circuit. An object to be detected is provided with a culture medium capable of culturing a colony. The control circuit is configured to: perform an acquisition process to acquire outputs of the optical sensors; perform regression on the outputs of the sensor panel to calculate an approximate line indicating a relation between the amount of light emitted from the light source to each of the optical sensors and the output of the optical sensor; and calculate a difference between the output of the optical sensor and the approximate line individually for each of the optical sensors, as a correction value. The correction value calculated individually is applied to the output of the corresponding optical sensor.

### CROSS-REFERENCE TO RELATED APPLICATION

This application claims the benefit of priority from Japanese Patent Application No. 2025-001825 filed on Jan. 6, 2025, the entire contents of which are incorporated herein by reference.

### BACKGROUND

### 1. Technical Field

What is disclosed herein relates to a detection device.

### 2. Description of the Related Art

Detection devices are known that enable detection of states of culture environments for culturing biological tissues or microorganisms using an optical sensor (for example, Japanese Patent Application Laid-open Publication No. 2005-87005).

To detect the state of a culture environment using an optical sensor, a plurality of optical sensors are two-dimensionally arranged to planarly detect the culture environment. The optical sensors may vary in the tendency of the output corresponding to the amount of detected light. The variations reduce the accuracy in detecting the state of the culture environment. This is because the variations may possibly cause the following situation: when a change in the amount of light occurs, one optical sensor can detect that the culture environment has changed, while another optical sensor different from the one optical sensor fails to detect the change.

For the foregoing reasons, there is a need for a detection device that can reduce the effects of variations in the outputs of a plurality of optical sensors.

### SUMMARY

According to an aspect, a detection device includes: a sensor panel having a detection area in which a plurality of optical sensors are two-dimensionally arranged; a light source configured to emit light; a member on which an object to be detected is to be placed so that the object to be detected is interposed between the detection area and the light source; and a control circuit configured to control an operation of the sensor panel and the light source and perform processing based on outputs of the optical sensors. The object to be detected is provided with a culture medium capable of culturing a colony. The control circuit is configured to: perform an acquisition process to operate the light source to generate light traveling toward the sensor panel after placement of the object to be detected, and acquire outputs of the sensor panel corresponding to intensities of light detected by the optical sensors; perform regression on the outputs of the sensor panel to calculate an approximate line indicating a relation between the amount of light emitted from the light source to each of the optical sensors and the output of the optical sensor; and calculate a difference between the output of the optical sensor and the approximate line individually for each of the optical sensors, as a correction value. The correction value calculated individually is applied to the output of the corresponding optical sensor.

### BRIEF DESCRIPTION OF THE DRAWINGS

FIG. 1 is a diagram illustrating a main configuration of a detection device;

FIG. 2 is a diagram illustrating a configuration example of a detection area and a wiring area;

FIG. 3 is a circuit diagram illustrating a circuit configuration of an optical sensor;

FIG. 4 is a schematic diagram schematically illustrating a configuration example of a detection system;

FIG. 5 is a schematic diagram illustrating a relation between one detection device and an external configuration;

FIG. 6 is a schematic view illustrating a positional relation between the main configuration of the detection device and an object to be detected;

FIG. 7 is a schematic view illustrating an object irradiated with light from a sensor panel in plan view;

FIG. 8 is a schematic diagram illustrating an outline of a method for detecting a colony;

FIG. 9 is a schematic view illustrating a configuration example of a light source 22;

FIG. 10 is a schematic diagram illustrating an example where some of a plurality of optical sensors arranged in the detection area are selected;

FIG. 11 is a graph indicating an example of the relation between the amount of light incident on each of the optical sensors selected in FIG. 10 and the output (Rawdata) of the optical sensor;

FIG. 12 is a graph indicating an example of the relation between the outputs of the optical sensors and a first-order approximate line;

FIG. 13 is a graph indicating the concept of the least squares method;

FIG. 14 is a graph indicating the relation between: an approximate curve corresponding to the relation between the magnitude of the amount of light indicated by a certain optical sensor and the level of the output (Rawdata) of the optical sensor, specific output samples constituting the approximate curve, and the first-order approximate line;

FIG. 15 is an enlarged view of a partial area illustrated in FIG. 14;

FIG. 16 is a schematic diagram illustrating an example of changes over time in the state of a culture medium in an object to be detected;

FIG. 17 is a graph indicating an example of first-order approximate lines corresponding to the states of the culture medium in the object to be detected;

FIG. 18 is a table indicating the output of the optical sensor when the amount of light is an amount of light 690 illustrated in FIG. 17;

FIG. 19 is a graph indicating the relation between: an approximate curve corresponding to the relation between the magnitude of the amount of light indicated by a certain optical sensor and the level of the output (Rawdata) of the optical sensor under the conditions different from those illustrated in FIG. 14; specific output samples constituting the approximate curve; and a first-order approximate line 640;

FIG. 20 is a flowchart illustrating processing performed in the detection device; and

FIG. 21 is a flowchart illustrating processing of automatic luminance adjustment.

### DETAILED DESCRIPTION

The following describes an embodiment of the present disclosure with reference to the drawings. What is disclosed herein is merely an example, and the present disclosure naturally encompasses appropriate modifications easily conceivable by those skilled in the art while maintaining the gist of the present invention. To further clarify the description, the drawings may schematically illustrate, for example, widths, thicknesses, and shapes of various parts as compared with actual aspects thereof. However, they are merely examples, and interpretation of the present disclosure is not limited thereto. The same element as that illustrated in a drawing that has already been discussed is denoted by the same reference numeral through the description and the drawings, and detailed description thereof may not be repeated where appropriate.

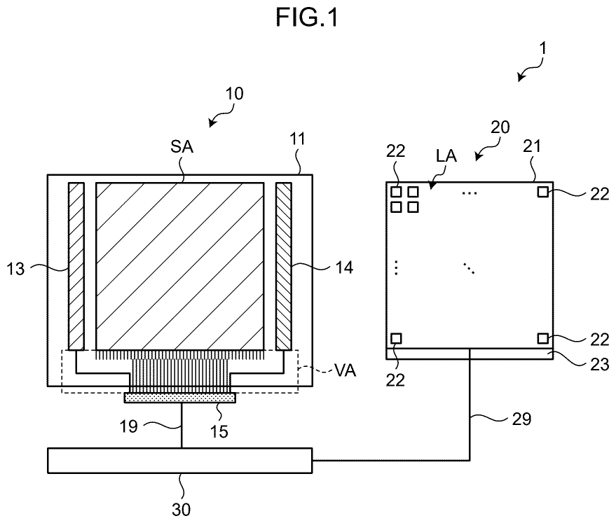

FIG. 1 is a diagram illustrating a main configuration of a detection device 1. The detection device 1 includes a sensor panel 10, a light source panel 20, and a control circuit 30. The sensor panel 10 and the light source panel 20 of the detection device 1 are coupled to the control circuit 30.

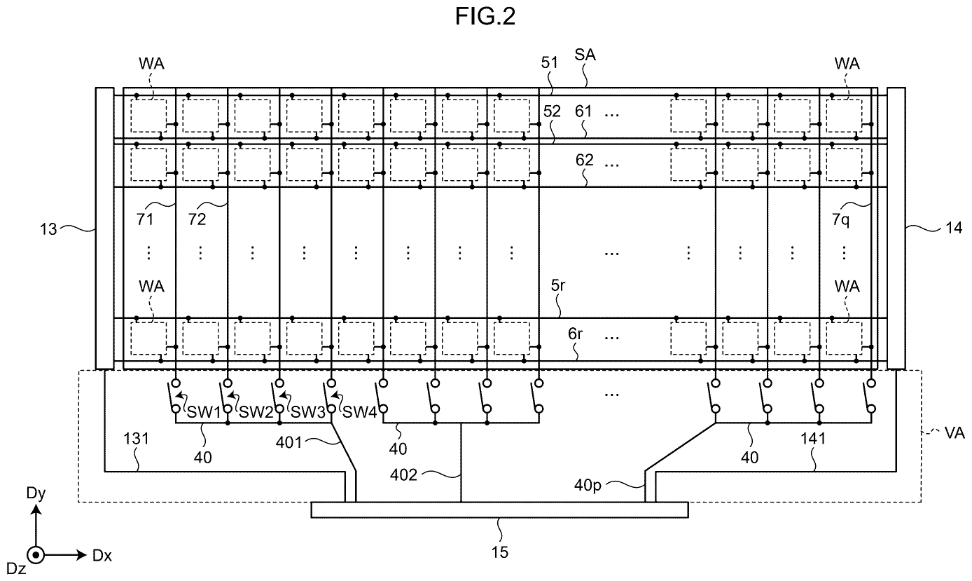

The sensor panel 10 is provided with a detection area SA (refer to FIG. 2) on a substrate 11. A reset circuit 13, a scan circuit 14, and a wiring area VA are mounted on the substrate 11. Components on the detection area SA, the reset circuit 13, and the scan circuit 14 are coupled to a detection circuit 15 via the wiring area VA.

The light source panel 20 has a light-emitting area LA that emits light to the detection area SA. The light source panel 20 is provided with a light source 22 on a substrate 21. The light source 22 includes a light-emitting element such as a light-emitting diode (LED), and is provided in the light-emitting area LA. In the example illustrated in FIG. 1, a plurality of the light sources 22 are arranged in a matrix having a row-column configuration on the substrate 21.

The light source panel 20 is provided with a light source drive circuit 23. Under the control of the control circuit 30, the light source drive circuit 23 controls turning on and off each of the light sources 22 and the luminance thereof when being turned on. The light sources 22 may be provided so as to allow individual control of light emission, or may be provided so as to emit light collectively.

The control circuit 30 performs various types of processing related to the operation of the detection device 1. Specifically, the control circuit 30 is a circuit, such as a field-programmable gate array (FPGA) or an application-specific integrated circuit (ASIC) that can implement a plurality of functions. The control circuit 30 is coupled to the detection circuit 15 via wiring 19, and obtains an output from the detection circuit 15. The control circuit 30 is coupled to the light source drive circuit 23 via wiring 29 and performs processing related to the lighting of the light sources 22, such as determination of lighting patterns of the light sources 22.

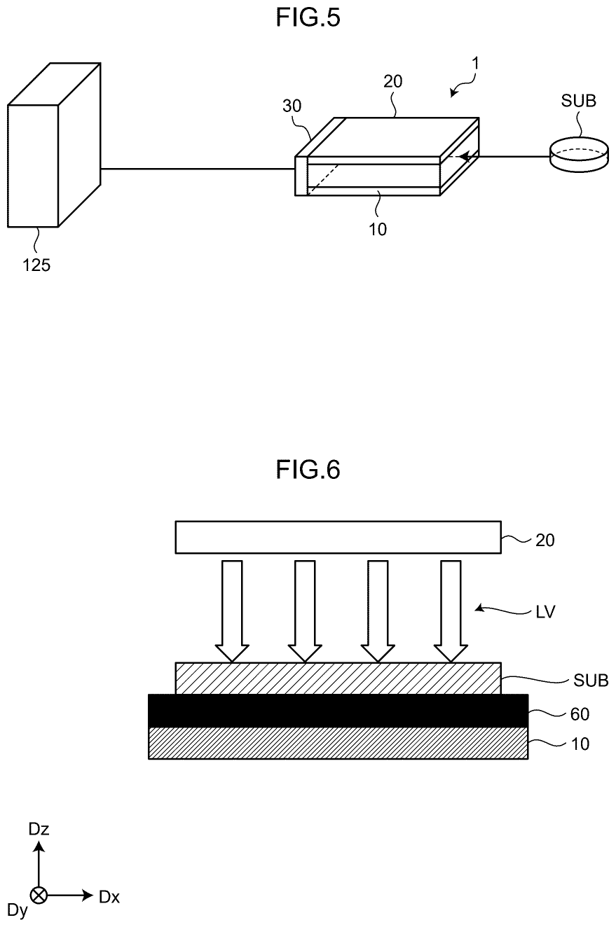

The control circuit 30 also performs processing related to detection of a colony in an object to be detected SUB (refer to FIG. 5). The processing will be described later.

Although not illustrated in the drawings, the detection device 1 includes an analog-to-digital conversion circuit, a digital-to-analog conversion circuit, and other components. The analog-to-digital conversion circuit allows an output from an optical sensor WA (refer to FIG. 2) transmitted through the detection circuit 15 to be handled by arithmetic processing by the control circuit 30. The digital-to-analog conversion circuit makes digital signals generated by the arithmetic processing of the control circuit 30 usable for controlling operations of the sensor panel 10 and the light source panel 20. Each of these circuits may be included, for example, in part or in whole in the control circuit 30, may be a function performed by a circuit mounted on a flexible printed circuit (FPC) provided as the wiring 19 or the wiring 29, or may be implemented in other ways in the detection device 1.

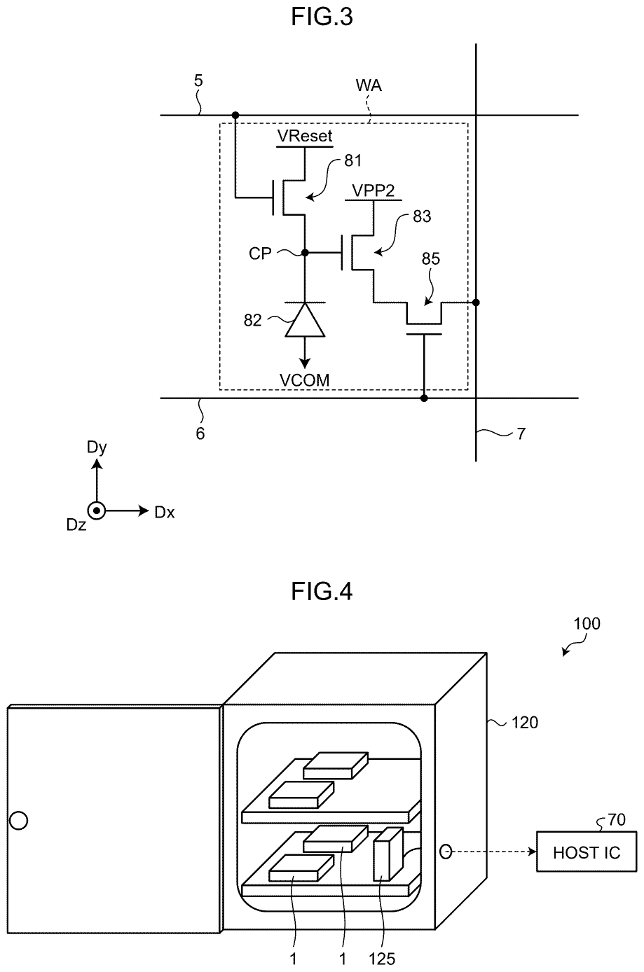

FIG. 2 is a diagram illustrating a configuration example of the detection area SA and the wiring area VA. A plurality of the optical sensors WA (FIG. 3) are provided in the detection area SA. In the embodiment, as illustrated in FIG. 2, the optical sensors WA are arranged in a matrix having a row-column configuration along a first direction Dx and a second direction Dy. The first direction Dx is orthogonal to the second direction Dy. In the following description, the term “third direction Dz” refers to a direction orthogonal to the first direction Dx and the second direction Dy.

The reset circuit 13 is coupled to reset signal transmission lines 51, 52, . . . , 5r. Hereinafter, the term “reset signal transmission line 5” refers to any one of the reset signal transmission lines 51, 52, . . . , 5r. The reset signal transmission line 5 is wiring along the first direction Dx. In the example illustrated in FIG. 2, r reset signal transmission lines 5 are arranged in the second direction Dy. r is a natural number equal to or larger than 2. The r reset signal transmission lines 5 are each coupled, at one end in the first direction Dx, to the reset circuit 13.

The scan circuit 14 is coupled to scan lines 61, 62, . . . , 6r. Hereinafter, the term “scan line 6” refers to any one of the scan lines 61, 62, . . . , 6r. The scan line 6 is wiring along the first direction Dx. In the example illustrated in FIG. 2, r scan lines 6 are arranged in the second direction Dy. The r scan lines 6 are each coupled, at the other end in the first direction Dx, to the scan circuit 14.

As illustrated in FIG. 2, the reset signal transmission lines 5 and the scan lines 6 are alternately arranged in the second direction Dy in the detection area SA. The reset circuit 13 and the scan circuit 14 illustrated in FIGS. 1 and 2 are arranged at locations facing each other with the detection area SA interposed therebetween, but the layout of the reset circuit 13 and the scan circuit 14 is not limited to this layout and can be changed as appropriate.

Signal lines 71, 72, . . . , 7q are also provided in the detection area SA. Hereinafter, the term “signal line 7” refers to any one of the signal lines 71, 72, . . . , 7q. The signal line 7 is wiring along the second direction Dy.

In the example illustrated in FIG. 2, q signal lines 7 are arranged in the first direction Dx. q is a natural number equal to or larger than 2. The q signal lines 7 are each coupled, at one end in the second direction Dy, to one of a plurality of switches (for example, a switch SW1, SW2, SW3, or SW4) included in a multiplexer 40.

The multiplexer 40 is provided in the wiring area VA. The multiplexer 40 includes a plurality of switches. In the example illustrated in FIG. 2, the switches SW1, SW2, SW3, and SW4 are illustrated as the switches. The switches included in one multiplexer 40 are turned on (conducting state) at different times from one another. During a period when one of the switches included in one multiplexer 40 is on (conducting state), the other switches are off (non-conducting state). The number of the multiplexers 40 depends on the number (q) of the signal lines 7. When the number of the switches is p, q/p is sufficient as the number of the multiplexers 40. When more than one multiplexer 40 are provided, each of the multiplexers 40 is coupled to the detection circuit 15 via an individual one of wire lines 401, 402, . . . , 40p.

The coupling between the signal lines 7 and the detection circuit 15 via the multiplexer 40 is merely exemplary and is not limited to this example. The signal lines 7 may be individually directly coupled to the detection circuit 15 in the wiring area VA. In the wiring area VA, the reset circuit 13 is coupled to the detection circuit 15 via wiring 131. In the wiring area VA, the scan circuit 14 is coupled to the detection circuit 15 via wiring 141.

In the detection of light by a PD 82 (refer to FIG. 3) provided in the optical sensor WA, the detection circuit 15 controls the operation timing of the reset circuit 13 and the scan circuit 14. The detection circuit 15 receives the output from the optical sensor WA. The detection circuit 15 converts signals received from the optical sensors WA into data that can be interpreted by the control circuit 30 and outputs the data to the control circuit 30. The detection circuit 15 of the embodiment is a micro-controller unit (MCU).

FIG. 3 is a circuit diagram illustrating a circuit configuration of the optical sensor WA. The first direction Dx and the second direction Dy in FIG. 3 merely correspond to the directions of the reset signal transmission lines 5, the scan lines 6, and the signal lines 7, and do not exactly indicate the relative positional relation of the circuit configuration in the optical sensor WA.

As illustrated in FIG. 3, a switching element 81, the PD 82, a transistor element 83, and a switching element 85 are provided in the optical sensor WA. The PD 82 is a photodiode (PD). The switching elements 81 and 85 and the transistor element are metal-oxide semiconductor field-effect transistors (MOSFETs).

The gate of the switching element 81 is coupled to the reset signal transmission line 5. One of the source and the drain of the switching element 81 is supplied with a reset potential VReset. The other of the source and the drain of the switching element 81 is coupled to the cathode of the PD 82 and the gate of the transistor element 83. Hereafter, the term “coupling part CP” refers to a point where the other of the source and the drain of the switching element 81 is coupled to the cathode of the PD 82 and the gate of the transistor element 83. A reference potential VCOM is given from the anode side of the PD 82. The potential difference between the reset potential VReset and the reference potential VCOM is set in advance, but the reset potential VReset and the reference potential VCOM may be variable. The reset potential VReset is higher than the reference potential VCOM.

The drain of the transistor element 83 serving as a source follower is supplied with an output source potential VPP2. The source of the transistor element 83 is coupled to one of the source and the drain of the switching element 85. The other of the source and the drain of the switching element 85 is coupled to the signal line 7. The gate of the switching element 85 is coupled to the scan line 6.

The reset potential VReset, the reference potential VCOM, and the output source potential VPP2 are supplied by the detection circuit 15 to the optical sensor WA based on, for example, electric power supplied via a power supply circuit (not illustrated) coupled to the detection circuit 15, but are not limited to being supplied in this way, and may be supplied in a different way as appropriate.

The output source potential VPP2 is set in advance. The potential on the source side of the transistor element 83 is a potential lower than the output potential of the PD 82 by a voltage (Vth) between the gate and the source of the transistor element 83. In this case, the potential on the source side of the transistor element 83 corresponds to the reset potential VReset and the reference potential VCOM. The potential of the output of the PD 82 corresponds to the photovoltaic power generated by the PD 82 according to the light detected by the PD 82 during an exposure period.

When the gate of the switching element 85 is turned on by a signal given from the scan circuit 14 via the scan line 6, the source and the drain of the switching element 85 are brought into a conducting state therebetween. This operation transmits, to the signal line 7 via the switching element 85, a signal (potential) transmitted via the transistor element 83 to the switching element 85. Thus, the output from the optical sensor WA is generated. Hereafter, the term “scan signal” refers to the signal (potential) given from the scan circuit 14 via the scan line 6. The scan circuit 14 is a circuit that outputs the scan signal.

The output of one PD 82 provided in one optical sensor WA corresponds to the intensity of the light detected by the PD 82 during the exposure period set in advance. The output of the PD 82 is reset in response to a signal given by the reset circuit 13 via the reset signal transmission line 5. When the signal turns on the gate of the switching element 81, the source and the drain of the switching element 81 are brought into a conducting state therebetween. This operation resets the potential of the coupling part CP to the reset potential VReset.

FIG. 4 is a schematic diagram schematically illustrating a configuration example of a detection system 100 including the detection device 1. As illustrated in FIG. 4, the detection system 100 includes a plurality of the detection devices 1, a host integrated circuit (IC) 70, and a coupling circuit 125. The detection devices 1 are electrically coupled to the common host IC 70 via the coupling circuit 125.

An incubator 120 illustrated in FIG. 4 is maintained such that an environment (temperature, humidity, and the like) therein is suitable for culturing a colony in the object to be detected SUB while a door is closed. The detection devices 1 are placed in the incubator 120. The object to be detected SUB is provided with a culture medium (e.g., agar) in which the colony can be cultured.

FIG. 5 is a schematic diagram illustrating a relation between one of the detection devices 1 and an external configuration. As illustrated in FIG. 5, the detection device 1 is coupled to the coupling circuit 125 by coupling the control circuit 30 to the coupling circuit 125. As illustrated in FIG. 5, the sensor panel 10 faces the light source panel 20. A gap where the object to be detected SUB can be located is provided between the sensor panel 10 and the light source panel 20.

The object to be detected SUB is made of a light-transmitting material and has a culture medium formed on the upper side thereof. The culture medium is a medium capable of culturing the colony. The term simply called “colony” refers to a colony formed by biological tissues or microorganisms cultured in the culture medium formed on the object to be detected SUB. More specifically, the object to be detected SUB is, for example, a glass Petri dish, but is not limited thereto, and may have another configuration that functions in the same way. The culture medium formed on the object to be detected SUB does not have a totally light-blocking property, and has such a degree of light-transmitting property where the degree of light transmission varies depending on the presence or absence of the colony and the thickness of the colony.

FIG. 6 is a schematic view illustrating a positional relation between the main configuration of the detection device 1 and the object to be detected SUB. When placing the object to be detected SUB between the sensor panel 10 and the light source panel 20, the object to be detected SUB is placed on a member 60, as illustrated in FIG. 6, for example. The member 60 serves as a member on which the object to be detected SUB can be placed so that the object to be detected SUB is interposed between the detection area SA and the light source panel 20.

In the embodiment, the sensor panel 10 is located below the object to be detected SUB and the light source panel 20 is located above the object to be detected SUB, as illustrated in FIGS. 5 and 6. The member 60 of the embodiment also serves as an optical member that limits the light emitted from the light sources 22 of the light source panel 20 and reaching the sensor panel 10. Specifically, the member 60 includes any one of a plate-shaped louver, a cylindrical opening, and a microlens. The plate-shaped louver has a plurality of plate-like structures arranged in parallel and having plate surfaces along the third direction Dz. The structures are preferably made of a material having a strong light-absorbing property. The member 60 is provided along a plane (Dx-Dy plane) orthogonal to the third direction Dz. The cylindrical opening penetrates the member 60 in the third direction Dz with respect to the base of the member 60. The base is preferably made of a material having a strong light-absorbing property. The microlens is a small lens with an optical axis along the third direction Dz. The base of the member 60 that supports the microlens is preferably made of a material having a strong light-absorbing property. Whether the member 60 includes the plate-shaped louver, the cylindrical opening, or the microlens, the member 60 as the optical member is provided in order to limit the direction of travel of the light emitted from the light sources 22 and reaching the sensor panel 10 to the third direction Dz or to a direction having a shallower inclination angle with respect to the third direction Dz.

In the embodiment, the member 60 serves as both the optical member and the member on which the object to be detected SUB can be placed. However, the member on which the object to be detected SUB can be placed may be provided separately from the optical member. For example, the member on which the object to be detected SUB can be placed may be a plate-like member provided with a hole capable of accommodating therein the object to be detected SUB. The arrangement of the light source panel 20 and the sensor panel 10 may be reversed. In that case, the member 60 is arranged, for example, above the object to be detected SUB and between the object to be detected SUB and the sensor panel 10.

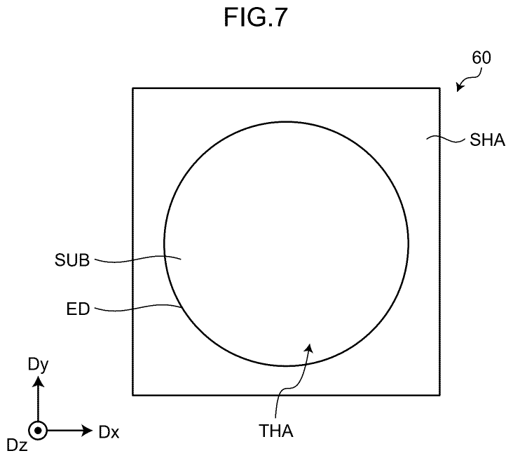

FIG. 7 is a schematic view illustrating an object irradiated with light from the sensor panel 10 in plan view. The planar viewpoint is a viewpoint from which a plane along the first direction Dx and the second direction Dy is directly viewed. An area THA is an area on one surface of the member 60 facing the object to be detected SUB and overlaps the object to be detected SUB. An area SHA is an area on the one surface of the member 60 facing the object to be detected SUB and does not overlap the object to be detected SUB. A boundary ED is a boundary between the area THA and the area SHA.

An intensity pattern indicating intensities of light detected by the optical sensors WA two-dimensionally arranged along the Dx-Dy plane indicates degrees of transmission of light through the area THA and the area SHA in the detection area SA. Assuming an output corresponding to the intensity of light detected by one optical sensor WA as a gradation value of one pixel, the combination of the outputs of the optical sensors WA arranged in the detection area SA can be regarded as a two-dimensional image by a combination of a plurality of pixels. In the following description, the term “image” refers to a two-dimensional image generated by the control circuit 30 by combining the outputs of the respective optical sensors WA arranged in the detection area SA, unless otherwise noted. In the following description, the term “scan process” refers to a process in which the control circuit 30 operates the light sources 22 of the light source panel 20 to generate the light traveling toward the sensor panel 10, and the control circuit 30 acquires the outputs of the sensor panel 10 corresponding to the intensities of the light detected by the optical sensors WA arranged in the detection area SA to generate the image.

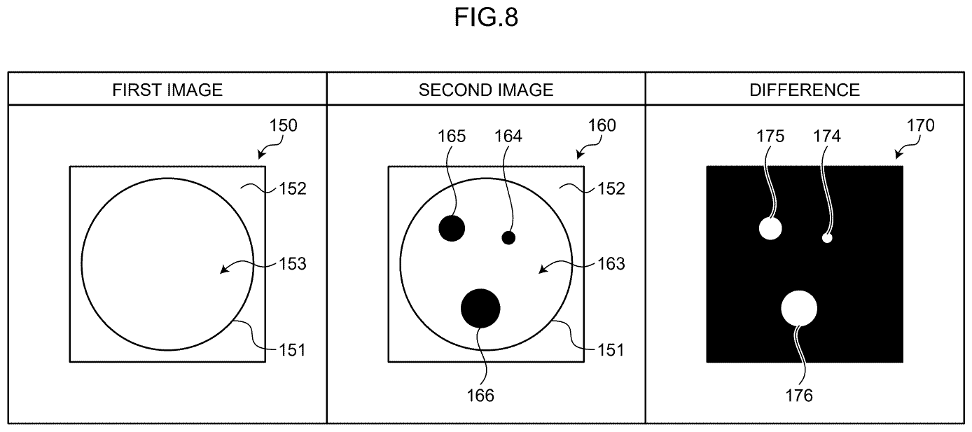

The above describes the configuration serving as a prerequisite for the detection of light by the optical sensors WA provided in the detection area SA, with reference to FIGS. 1 to 7. The following describes a method for detecting the colony using the image, with reference to FIG. 8.

FIG. 8 is a schematic diagram illustrating an outline of the method for detecting the colony. “First image” in FIG. 8 is an image before the colony grows. “Second image” in FIG. 8 is an image after the colony has grown. An image 150 illustrated in the “first image” in FIG. 8 includes a boundary 151, an outside portion 152, and an inside portion 153. The outside portion 152 is a portion on the outer side of the boundary and corresponds to a portion outside the object to be detected SUB (or the culture medium). The inside portion 153 is a portion on the inner side of the boundary and corresponds to a portion inside the object to be detected SUB (or the culture medium). An image 160 illustrated in “second image” in FIG. 8 includes the boundary 151, the outside portion 152, and an inside portion 163. The inside portion 163 is a portion on the inner side of the boundary and corresponds to a portion inside the object to be detected SUB (or the culture medium). The inside portion 163 includes dark portions 164, 165, 166. The growth of the colony occurs because microorganisms or the like are sufficiently cultured in the culture medium.

The boundary 151 indicates a dark portion generated corresponding to the boundary ED. Specifically, the boundary 151 is formed by outputs corresponding to the intensities of the light detected by the optical sensors WA arranged so as to overlap the boundary between the area SHA and the area THA in plan view. The outside portion 152 reflects the intensities of light transmitted through the area SHA. Specifically, the outside portion 152 is formed by outputs corresponding to the intensities of the light detected by the optical sensors WA arranged so as to overlap the area SHA in plan view.

The inside portion 153 and the inside portion 163 reflect the intensities of light transmitted through the area THA. Specifically, the inside portion 153 is formed by outputs corresponding to the intensities of the light detected by the optical sensors WA arranged so as to overlap the area THA in plan view. The brightness of light in the inside portion 153 reflects the intensities of light transmitted through the area THA before the colony grows. The brightness of light in the inside portion 163 reflects the intensities of light transmitted through the area THA after the colony has grown. In other words, the difference between the inside portion 153 and the inside portion 163 is the difference before and after the change in brightness of light caused by the growth of the colony. The dark portions 164, 165, and 166 are each generated by the growth of the colony in the object to be detected SUB overlapping the area THA in plan view. The area where the colony has grown has relatively lower light transmittance than that of the culture medium itself provided in the object to be detected SUB. As a result, the dark portions 164, 165, 166 appear in the image 160 as relatively darker parts than the inside portion 163.

The boundary 151 and the outside portion 152 are the same between the image 150 and the image 160. This is because the appearance of the relatively darker parts, such as the dark portions 164, 165, and 166, due to the growth of the colony is limited to an area corresponding to the inside of the area THA where the colony can grow in the object to be detected SUB. The boundary 151 and the outside portion 152 do not overlap the inside of the area THA. Therefore, the boundary 151 and the outside portion 152 are formed in the image 150 and the image 160 with the output corresponding to substantially the same light intensity, regardless of whether before or after the growth of the colony.

“Difference” in FIG. 8 is the difference between “first image” and “second image”. A differential image 170 illustrated in “difference” in FIG. 8 includes differential areas 174, 175, and 176. The differential area 174 corresponds to the dark portion 164 in the image 160. The differential area 175 corresponds to the dark portion 165 in the image 160. The differential area 176 corresponds to the dark portion 166 in the image 160. The boundary 151 and the outside portion 152 are the same between the image 150 and the image 160.

The inside portion 153 of the image 150 does not include the dark portions 164, 165, and 166. In contrast, the inside portion 163 of the image 160 includes the dark portions 164, 165, and 166. Therefore, the differential image 170 as “difference” between the image 150 as the “first image” and the image 160 as the “second image” illustrated in FIG. 8 includes the differential areas 174, 175, and 176 corresponding to the dark portions 164, 165, and 166, as differences between the inside portion 153 and the inside portion 163. When the total area of the differential areas (e.g., the differential areas 174, 175, and 176) in the “difference” (e.g., the differential image 170) is equal to or larger than a predetermined area (size), the control circuit 30 determines that the colony has sufficiently grown in the culture medium in the object to be detected SUB.

In the embodiment, a correction value, which will be described later, is calculated immediately after the object to be detected SUB is placed in the detection device 1 (refer to FIG. 5). After the correction value is calculated, the scan process is performed to acquire the image (such as the image 150) illustrated in the “first image” in FIG. 8 as the initial image. Then, the scan process is performed again each time a predetermined time elapses. After the elapse of the predetermined time occurs more than once, the control circuit 30 performs the process to obtain the difference between the image acquired in the latest scan process and the initial image. This operation obtains the difference (such as the differential image 170) as illustrated in the “difference” in FIG. 8. Thus, if the image acquired in the latest scan process is the image as illustrated in the “second image” (such as the image 160), the differential image 170 is acquired as the difference.

The predetermined time is five minutes, for example, but is not limited thereto, and can be changed as appropriate. The predetermined time is preferably appropriately set according to conditions, such as a growth rate of the colony that is assumed based on environmental conditions in the incubator 120 accommodating the detection device 1 holding therein the object to be detected SUB.

In this way, the control circuit 30 operates the light sources 22 to generate the light traveling toward the sensor panel 10 after the placement of the object to be detected SUB, and performs acquisition processes to acquire the outputs of the sensor panel 10 corresponding to the light intensities detected by the optical sensors WA.

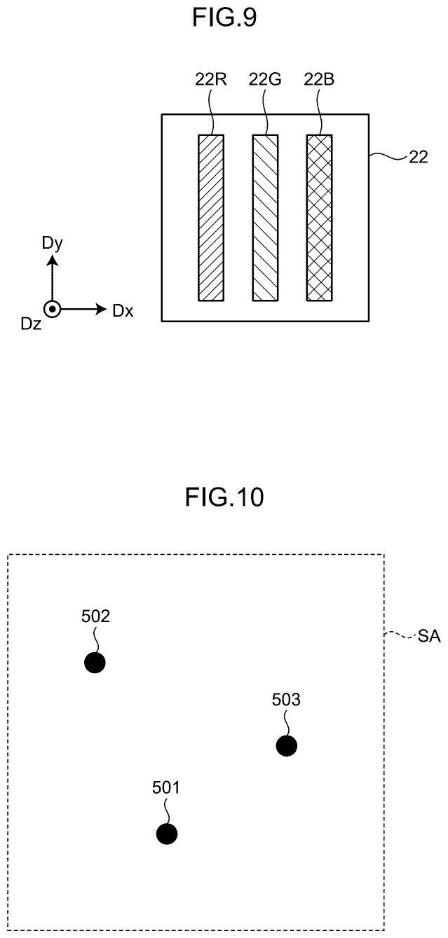

FIG. 9 is a schematic view illustrating a configuration example of the light source 22. As illustrated in FIG. 9, the light source 22 includes a first light source 22R, a second light source 22G, and a third light source 22B. The first light source 22R, the second light source 22G, and the third light source 22B are light-emitting elements (such as LEDs) that emit light in different colors. In the embodiment, the first light source 22R emits red (R) light. The second light source 22G emits green (G) light. The third light source 22B emits blue (B) light. The first light source 22R, the second light source 22G, and the third light source 22B are provided so as to allow individual control of light emission.

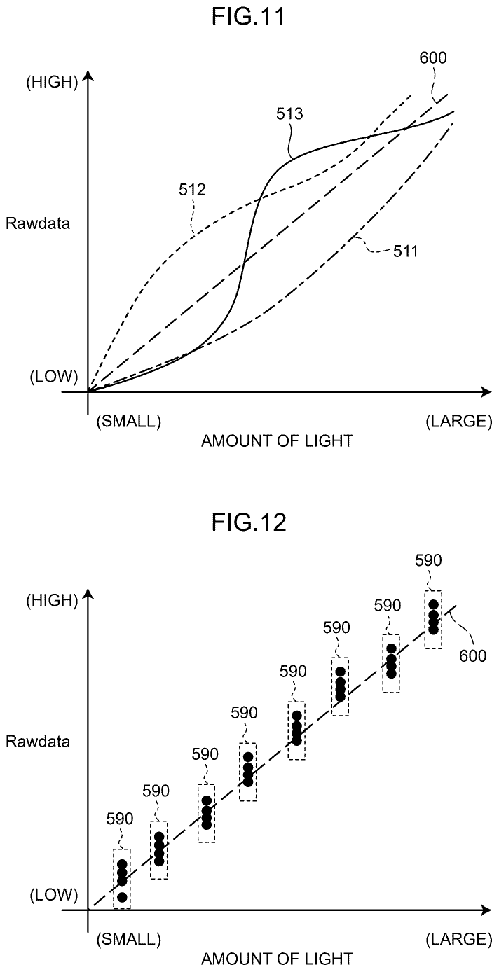

The output characteristics of the optical sensors WA may vary. Specifically, when the same amount of light is incident on the optical sensors WA, the outputs from the optical sensors WA are not always the same and may vary. The following describes the variations with reference to FIGS. 10 and 11.

FIG. 10 is a schematic diagram illustrating an example where some of the optical sensors WA arranged in the detection area SA are selected. As described with reference to FIG. 2, the optical sensors WA are two-dimensionally arranged along the first direction Dx and the second direction Dy in the detection area SA. FIG. 10 illustrates three optical sensors WA arranged at different positions in the detection area SA out of the optical sensors WA. In FIG. 10, one of the three optical sensors WA is referred to as an optical sensor 501, another one as an optical sensor 502, and the remaining one as an optical sensor 503.

FIG. 11 is a graph indicating an example of the relation between the amount of light incident on each of the optical sensors WA selected in FIG. 10 and the output (Rawdata) of the optical sensor WA. An approximate curve 511 in FIG. 11 indicates the output tendency of the optical sensor 501 in FIG. 10. An approximate curve 512 in FIG. 11 indicates the output tendency of the optical sensor 502 in FIG. 10. An approximate curve 513 in FIG. 11 indicates the output tendency of the optical sensor 503 in FIG. 10.

The vertical axis in the graphs in FIG. 11 and FIGS. 12, 14, 17, and 19, which will be described later, indicates the level of the output (Rawdata) of the optical sensor WA. The horizontal axis in the graphs in FIGS. 11, 12, 14, 17, and 19 indicates the magnitude of the amount of light.

The relation between the amount of light incident on the optical sensor WA and the output of the optical sensor WA are preferably linearly proportional, like a first-order approximate line 600 in FIG. 11 in which the magnitude of the amount of light and the level of the output (Rawdata) of the optical sensor WA linearly proportional.

In the approximate curves 511, 512, and 513, the relation between the magnitude of the amount of light and the level of the output (Rawdata) of the optical sensor WA is not first-order linear, unlike the first-order approximate line 600. In addition, the approximate curve 511, the approximate curve 512, and the approximate curve 513 have different relations between the amount of light and the output of the optical sensor WA. In other words, the output tendency of the optical sensor 501 indicated by the approximate curve 511, that of the optical sensor 502 indicated by the approximate curve 512, and that of the optical sensor 503 indicated by the approximate curve 513 are different from one another.

More specifically, in the approximate curve 511, the level of the output corresponding to the magnitude of the amount of light is lower as a whole than that of the first-order approximate line 600. In the approximate curve 512, the level of the output corresponding to the magnitude of the amount of light remains higher as a whole than that of the first-order approximate line 600. In the approximate curve 513, the level of the output corresponding to the magnitude of the amount of light is lower than that of the first-order approximate line 600 when the amount of light is small. When the amount of light increases to some extent, the level of the output corresponding to the magnitude of the amount of light of the approximate curve 513 becomes higher than that of the first-order approximate line 600 and the approximate curve 512. When the amount of light increases further, the level of the output corresponding to the magnitude of the amount of light of the approximate curve 513 is lower than that of the first-order approximate line 600 and the approximate curve 512.

While the optical sensors 501, 502, and 503 are given as examples of the optical sensors WA in the description with reference to FIGS. 10 and 11, there may be variability among the optical sensors WA other than the optical sensors 501, 502, and 503 in the relation between the magnitude of the amount of light and the level of the output (Rawdata) of the optical sensor WA.

The variations in the relation between the magnitude of the amount of light and the level of the output (Rawdata) of the optical sensor WA are undesirable in detecting the growth of the colony described with reference to FIG. 8. This is because the variations may possibly cause the following situation: when a decrease in the amount of light occurs, some optical sensors WA can detect dark portions, such as the dark portions 164, 165, and 166, while other optical sensors WA fail to detect dark portions, such as the dark portions 164, 165, and 166. In other words, the variations in the relation between the magnitude of the amount of light and the level of the output (Rawdata) of the optical sensor WA are undesirable for accurately detecting the growth of the colony.

In other words, the relation between the magnitude of the amount of light and the level of the output (Rawdata) of the optical sensor WA preferably converges on a common relation among the optical sensors WA. In practice, however, at least some of the optical sensors WA have errors with respect to the common relation. The errors appear as the variations.

Therefore, in the embodiment, a mechanism is provided that corrects the output of the optical sensor WA corresponding to the amount of light for the purpose of causing substantially all the optical sensors WA to have a common relation between the magnitude of the amount of light and the level of the output (Rawdata) of the optical sensor WA. The following describes the correction with reference to FIGS. 12 to 21.

FIG. 12 is a graph indicating an example of the relation between the outputs of the optical sensors WA and the first-order approximate line 600. An output group 590 illustrated in FIG. 12 is a set of the outputs of a plurality of optical sensors WA. A plurality of points in the output group 590 schematically represent the outputs of the respective optical sensors WA. One output group 590 includes the outputs of the optical sensors WA irradiated with a certain amount of light. In other words, a plurality of output groups 590 illustrated in FIG. 12 individually indicate the outputs of the optical sensors WA when irradiated with different amounts of light.

The detection device according to the embodiment performs processing for deriving the relation between the magnitude of the amount of light and the level of the output (Rawdata) of the optical sensor WA by linear regression based on the outputs of the optical sensors WA. In other words, the first-order approximate line 600 is linearly obtained by performing linear regression on the outputs of the optical sensors WA, such as the output groups 590 illustrated in FIG. 12. Thus, the first-order approximate line 600 is determined to be the criterion of the relation between the magnitude of the amount of light and the level of the output (Rawdata) of the optical sensor WA. More specifically, the least squares method is employed in the embodiment.

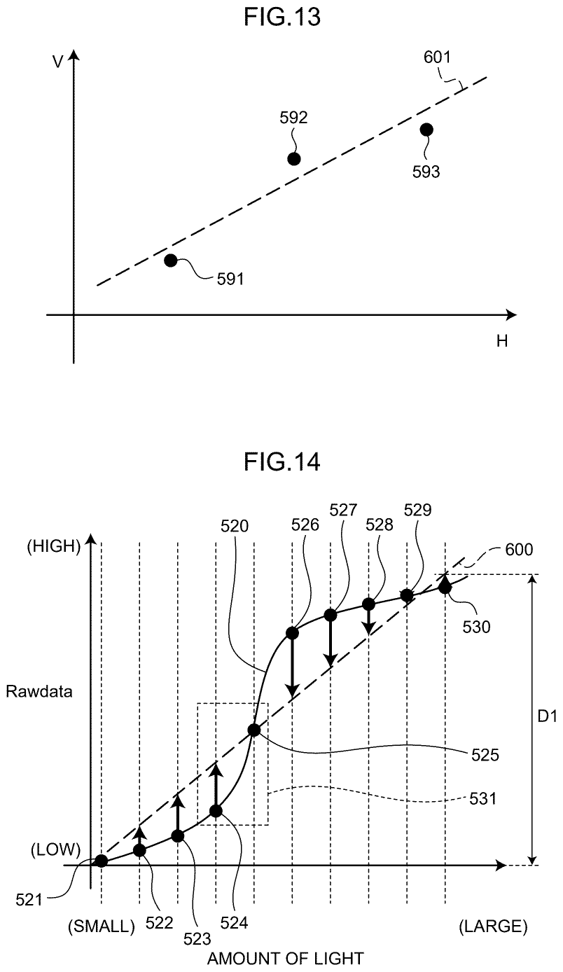

FIG. 13 is a graph indicating the concept of the least squares method. Outputs 591, 592, and 593 illustrated in FIG. 13 represent the outputs of the optical sensors WA corresponding to different amounts of light. A first-order approximate line 601 represents an approximate line of the outputs 591, 592, and 593 obtained by the least squares method. In FIG. 13, the vertical axis indicates V, and the horizontal axis indicates H.

For example, let us assume that the output 591 is (h₁, v₁). Let us assume that the output 592 is (h₂, v₂). Let us assume that the output 593 is (h₃, v₃). h₁, h₂, and h₃ are the values on the horizontal axis (H). v₁, v₂, and v₃ are the values on the vertical axis (V).

In the least squares method, the averages of h₁, h₂, and h₃, and v₁, v₂, and v₃ are calculated first. Let us assume that the average of h₁, h₂, and h₃ is h. Let us assume that the average of v₁, v₂, and v₃ is v.

In the least squares method, the variance of h is calculated. The variance herein means variance as a term in regression analysis. Specifically, the difference (deviation) between each of the original values (h₁, h₂, and h₃), from which the average (h) is calculated, and the average (h) is squared. In other words, (h−h₁)², (h−h₂)², and (h−h₃)² are calculated. The sum of the squared values is calculated as the sum of squared deviations. In other words, the sum of squared deviations in this case is expressed as (h−h₁)²+(h−h₂)²+(h−h₃)². The variance is calculated by dividing the sum of squared deviations by the number of parameters by which the average (h) is calculated. The number of parameters by which the average (h) is calculated in this case is the number of outputs 591, 592, and 593, that is, three. In the following description, the variance of h is referred to as Sh². Therefore, in the example illustrated in FIG. 13, Sh²={(h−h₁)²+(h−h₂)²+(h−h₃)²}/3 is satisfied.

In the least squares method, the covariance of h and v is calculated. The covariance herein means covariance as a term in regression analysis. Specifically, the difference (deviation) between each of the original values from which the average is calculated and the average is calculated on each of the horizontal axis (H) and the vertical axis (V). In other words, (h−h₁), (h−h₂), and (h−h₃) are calculated for the vertical axis (H). Similarly, (v−h₁), (v−h₂), and (v−h₃) are calculated for the vertical axis (V). Then, the deviation on the horizontal axis (H) is multiplied by the deviation on the vertical axis (V) in units of the optical sensor WA. In other words, (h−h₁)×(v−v₁) is calculated for the output 591. Similarly, (h−h₂)×(v−v₂) is calculated for the output 592. Similarly, (h−h₃)×(v−v₃) is calculated for the output 593. Then, the sum of products is calculated by adding the values obtained by multiplying the deviation on the horizontal axis (H) by the deviation on the vertical axis (V) in units of the optical sensor WA. In other words, (h−h₁)×(v−v₁)+(h−h₂)×(v−v₂)+(h−h₃)×(v−v₃) is calculated as the sum of products. The covariance is calculated by dividing the sum of products by the number of parameters by which the average (h, v) is calculated. In the following description, the covariance of h is referred to as Shv. Therefore, in the example illustrated in FIG. 13, Shv={(h−h₁)×(v−v₁)+(h−h₂)×(v−v₂)+(h−h₃)×(v−v₃)}/3 is satisfied.

An approximate line derived by the least squares method, such as the first-order approximate line 601 illustrated in FIG. 13, is a first-order line expressed by V=aH+b. a is the product of the variance of h and the covariance of h and v. Therefore, a=Sh²×Shv is satisfied. b is the value obtained by subtracting the product of a and h from v. Therefore, b=v−ah is satisfied. Thus, the first-order approximate line 601 illustrated in FIG. 13 is expressed by V=(Sh²×Shv)H+(v−ah).

To apply the concept of the least squares method to the outputs of the actual optical sensors WA, the number of parameters by which the average is calculated is set to the number of optical sensors WA arranged in the detection area SA, and the parameters of the outputs 591, 592, and 593, such as (h₁, v₁), (h₂, v₂), and (h₃, v₃), are set to the outputs (e.g., the output groups 590 illustrated in FIG. 12) corresponding to the amounts of light incident on the respective optical sensors WA. As a result, the first-order approximate line 600 is calculated as the criterion of the relation between the magnitude of the amount of light and the level of the output (Rawdata) of the optical sensor WA corresponding to the output groups 590 illustrated in FIG. 12. As described above with reference to FIG. 13, the detection device according to the embodiment performs regression (e.g., linear regression by the least squares method) on the outputs of the sensor panel 10 to calculate an approximate line (e.g., the first-order approximate line 600 illustrated in FIG. 12) indicating the relation between the amount of light emitted from the light source 22 to the optical sensor WA and the output of the optical sensor WA.

The detection device according to the embodiment calculates and applies a correction value (calib) individually to each of the optical sensors WA. The correction value (calib) is a value to match the outputs of the optical sensors WA to the criterion (e.g., the first-order approximate line 600) of the relation between the magnitude of the amount of light and the level of the output (Rawdata) of the optical sensor WA derived by linear regression (e.g., the least squares method). In the following description, the coordinates (x, y) are used to represent the arrangement of each of the optical sensors WA illustrated in FIG. 2, where x indicates the position in the first direction Dx and y indicates the position in the second direction Dy.

FIG. 14 is a graph indicating the relation between: an approximate curve 520 corresponding to the relation between the magnitude of the amount of light indicated by a certain optical sensor WA and the level of the output (Rawdata) of the optical sensor WA; output samples 521, 522, . . . 530 serving as specific output samples constituting the approximate curve 520; and the first-order approximate line 600. The amounts of light incident on the optical sensor WA when the output samples 521, 522, . . . 530 are obtained are different from one another.

The output samples 521, 522, . . . 530 illustrated in FIG. 14 each represent an individual error with respect to the first-order approximate line 600. For example, the output sample 525 is substantially on the first-order approximate line 600 and has no error or a very small error with respect to the first-order approximate line 600. By contrast, the output samples 521, 522, 523, 524, and 530 are low with respect to the first-order approximate line 600. The output samples 526, 527, 528, and 529 are high with respect to the first-order approximate line 600.

The correction value (calib) serves as an addition/subtraction value that enables the outputs of the optical sensor WA, such as the approximate curve 520, to be considered the same as the first-order approximate line 600. As described above, the output samples 521, 522, . . . 530 each represent an individual error with respect to the first-order approximate line 600. Therefore, the correction value (calib) is applied individually to each of the outputs of the optical sensor WA (e.g., the output samples 521, 522, . . . 530) corresponding to different amounts of light. In other words, the correction value (calib) for a certain optical sensor WA is a set of addition/subtraction values applied individually to each of the outputs of the optical sensor WA (e.g., the output samples 521, 522, . . . 530) corresponding to different amounts of light.

Specifically, the three upward arrows extending from the output samples 522, 523, and 524 to the first-order approximate line 600 in FIG. 14 have different lengths in the vertical axis direction. The three downward arrows extending from the output samples 526, 527, and 528 to the first-order approximate line 600 have different lengths in the vertical direction. Although not illustrated, the output samples 521, 525, and 530 may be considered to also have arrows indicating the degree of correction corresponding to the errors in the vertical direction between them and the first-order approximate line 600. These arrows each indicate the addition/subtraction value applied individually to each of the outputs of the optical sensor WA corresponding to different amounts of light. These individual addition/subtraction values are each calculated from the difference between an “output corresponding to a certain amount of light” calculated as the first-order approximate line 600 and an “actual output corresponding to the certain amount of light” from the optical sensor WA. The term “addition/subtraction value” is used because of the following characteristics: if the addition/subtraction value is a negative value, the value effectively functions as a subtraction value when the arithmetic operation is addition, and the value effectively functions as an addition value when the arithmetic operation is subtraction. In the embodiment, the correction value (calib) is calculated on the assumption that an arithmetic operation of subtracting the correction value (calib) from the value of the output of the optical sensor WA is performed.

The correction value (calib) is individually calculated so as to be applied individually to the output of each of the optical sensors WA. If each of the optical sensors WA can be distinguished by x and y in the coordinates (x, y), the correction value (calib) can also be distinguished by the coordinates (x, y) of the optical sensor WA. In the following description, calib(x, y) is the correction value applied to the optical sensor WA arranged at the coordinates (x, y). In other words, the correction value (calib) is a set of correction values (calib(x, y)) applied individually to the respective optical sensors WA.

As described with reference to FIG. 14, the detection device according to the embodiment calculates the difference between the output of the optical sensor WA and the approximate line (e.g., the first-order approximate line 600 illustrated in FIG. 12) individually for the output from each of the optical sensors, as the correction value (calib(x, y)).

In the embodiment, a scan process is performed to obtain the correction value (calib), but there is a practical limit to the number of times of the process for obtaining the “actual output corresponding to the certain amount of light” from the optical sensor WA. Therefore, in the embodiment, a plurality of sampling amounts of light are set within the predetermined range of the amount of light from the minimum value to the maximum value. Based on this, the detection device according to the embodiment performs processing of determining the output of the optical sensor WA obtained at each of the sampling amounts of light to be an “actual output corresponding to a certain sampling amount of light”. A correction value obtained by an interpolation process is applied to the output of the optical sensor WA not directly corresponding to any of the determined sampling amounts of light.

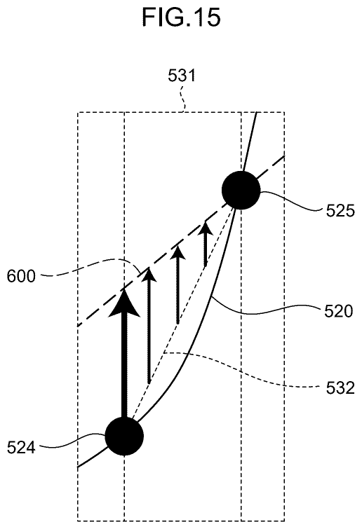

FIG. 15 is an enlarged view of a partial area 531 illustrated in FIG. 14. The following describes the interpolation process performed to apply the correction value to the output of the optical sensor WA corresponding to the amount of light not corresponding to any of the sampling amounts of light with reference to FIG. 15. The approximate curve 520 illustrated in FIGS. 14 and 15 is what is called an approximate curve. In the interpolation process, among the “actual outputs corresponding to the certain sampling amount of light”, a first-order line connecting two outputs corresponding to the amounts of light that are more approximate to each other is regarded as the output of the optical sensor WA corresponding to the amount of light not corresponding to the sampling amount of light. In other words, let us assume a case where each of the output sample 524 and the output sample 525 is the “actual output corresponding to the certain sampling amount of light”. In this case, the output of the optical sensor WA corresponding to the amount of light not corresponding to the sampling amount of light between the output samples 524 and 525 is considered to be on a first-order line 532 connecting the output samples 524 and 525. With the interpolation process, the addition/subtraction value is obtained, which corresponds to the difference between the “output of the optical sensor WA corresponding to the amount of light not corresponding to the sampling amount of light” obtained in this manner and the “output corresponding to the certain amount of light” calculated as the first-order approximate line 600. The obtained addition/subtraction value is applied to the output of the optical sensor WA corresponding to the amount of light not corresponding to the sampling amount of light.

In the embodiment, the first light source 22R, the second light source 22G, and the third light source 22B described with reference to FIG. 9 are individually controlled to emit light. That is, when one of the first light source 22R, the second light source 22G, and the third light source 22B is turned on, the other two are not turned on. In other words, one scan process includes a scan process under the condition that the first light source 22R is turned on and neither the second light source 22G nor the third light source 22B is turned on (first light detection), a scan process under the condition that the second light source 22G is turned on and neither the first light source 22R nor the third light source 22B is turned on (second light detection), and a scan process under the condition that the third light source 22B is turned on and neither the first light source 22R nor the second light source 22G is turned on (third light detection). In the correction value calculation, the correction value for the output of the optical sensor WA corresponding to light from the first light source 22R, the correction value for the output of the optical sensor WA corresponding to light from the second light source 22G, and the correction value for the output of the optical sensor WA corresponding to light from the third light source 22B are individually calculated, and these calculated values are combined into the correction value (calib).

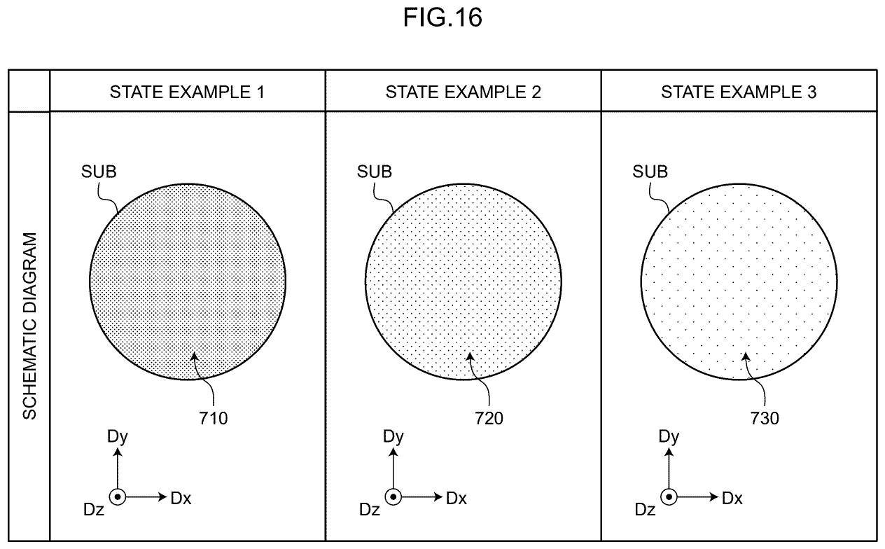

The basic concept of the correction value (calib) has been described above. The detection device according to the embodiment further performs an arithmetic operation based on the tendency of the change in the output of the optical sensor WA that may change depending on the state of the culture medium in the object to be detected SUB. The following describes the concept of the arithmetic operation with reference to FIGS. 16 to 19.

FIG. 16 is a schematic diagram illustrating an example of changes over time in the state of the culture medium in the object to be detected SUB. “State example 1” illustrated in FIG. 16 indicates a color 710 that is the color of the culture medium in the object to be detected SUB at a certain point in time (e.g., immediately after the object to be detected SUB is placed in the detection device 1). “State example 2” indicates a color 720 that is the color of the culture medium in the object to be detected SUB at a point in time significantly later than that of “state example 1”. “State example 3” indicates a color 730 that is the color of the culture medium in the object to be detected SUB at a point in time significantly later than that of “state example 2”. As illustrated in FIG. 16, the color of the culture medium in the object to be detected SUB may change over time during the culture of the colony. The changes are caused by a plurality of reasons, including the characteristics of change over time (chemical change) of the culture medium itself, consumption of the components in the culture medium by the subject being cultured in the colony, for example.

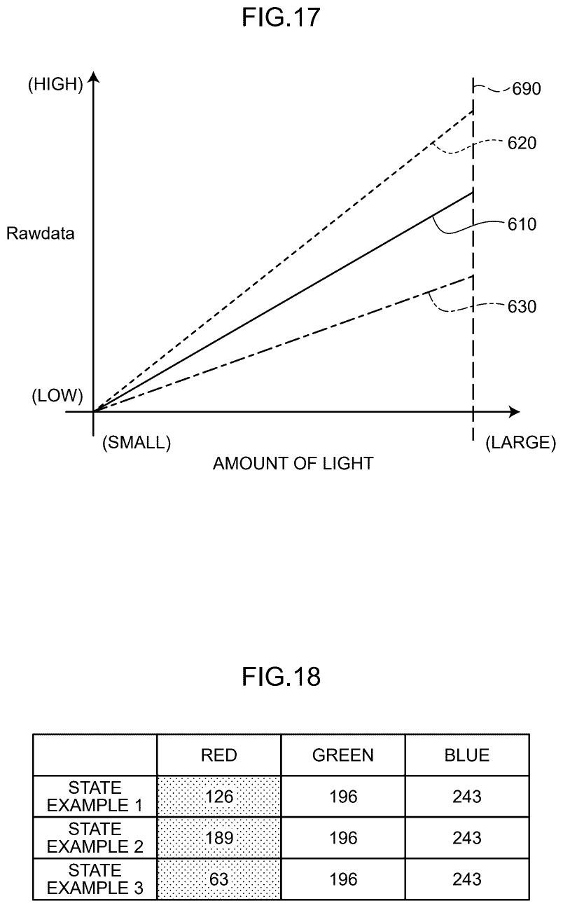

FIG. 17 is a graph indicating an example of first-order approximate lines corresponding to the states of the culture medium in the object to be detected SUB. A first-order approximate line 610 illustrated in FIG. 17 is the first-order approximate line 600 calculated based on the output of the optical sensor WA due to light transmitted through the object to be detected SUB and detected by the optical sensor WA in “state example 1” illustrated in FIG. 16. A first-order approximate line 620 illustrated in FIG. 17 is the first-order approximate line 600 calculated based on the output of the optical sensor WA due to light transmitted through the object to be detected SUB and detected by the optical sensor WA in “state example 2” illustrated in FIG. 16. A first-order approximate line 630 illustrated in FIG. 17 is the first-order approximate line 600 calculated based on the output of the optical sensor WA due to light transmitted through the object to be detected SUB and detected by the optical sensor WA in “state example 3” illustrated in FIG. 16.

FIG. 18 is a table indicating the output of the optical sensor WA when the amount of light is an amount of light 690 illustrated in FIG. 17. FIG. 18 indicates the color of the culture medium in “state example 1”, “state example 2”, and “state example 3” by RGB values. “RED” in FIG. 18 indicates the output from the optical sensor WA obtained under the condition that the first light source 22R is supplied with a current of the amount of light corresponding to the amount of light 690 and turned on. “GREEN” in FIG. 18 indicates the output from the optical sensor WA obtained under the condition that the second light source 22G is supplied with a current of the amount of light corresponding to the amount of light 690 and turned on. “BLUE” in FIG. 18 indicates the output from the optical sensor WA obtained under the condition that the third light source 22B is supplied with a current of the amount of light corresponding to the amount of light 690 and turned on.

As illustrated in FIGS. 17 and 18, when the state of the culture medium in the object to be detected SUB changes over time and the color of the culture medium changes like the colors 710, 720, and 730, the first-order approximate line calculated as the first-order approximate line 600 described with reference to FIG. 12 also changes due to the changes in color like the first-order approximate lines 610, 620, and 630.

The detection device according to the embodiment applies the change in the output of the optical sensor WA due to the change over time of the culture medium in the object to be detected SUB described with reference to FIGS. 16 to 18 to the first-order approximate line 600. Specifically, the detection device according to the embodiment performs processing of calculating the average of the outputs of all the optical sensors WA at each point in time in units of the point in time, and setting the ratio between the averages as the degree of change in the output due to the change over time occurring between the two different points in time.

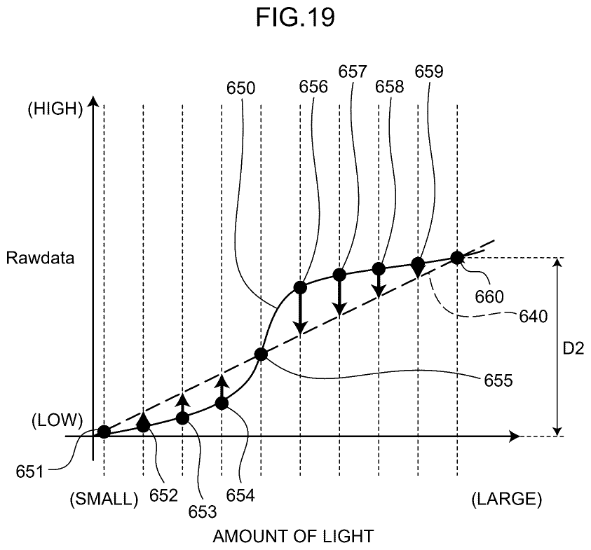

FIG. 19 is a graph indicating the relation between: an approximate curve 650 corresponding to the relation between the magnitude of the amount of light indicated by a certain optical sensor WA and the level of the output (Rawdata) of the optical sensor WA under the conditions different from those illustrated in FIG. 14; output samples 651, 652, . . . 660 serving as specific output samples constituting the approximate curve 650; and a first-order approximate line 640.

For example, let us assume a case where the output of the optical sensor WA at the point in time when the first-order approximate line 640 illustrated in FIG. 19 is calculated is obtained later than the output of the optical sensor WA at the point in time when the first-order approximate line 600 illustrated in FIG. 14 is calculated. In this case, the ratio of the average of the outputs of the optical sensor WA (output samples 521, 522, . . . 530) illustrated in FIG. 14 to the average of the outputs of the optical sensor WA (output samples 651, 652, . . . 660) illustrated in FIG. 19 is reflected in the ratio of the first-order approximate line 600 to the first-order approximate line 640 (ratio of the height in the vertical axis direction) under the condition that the amounts of light (horizontal axis) are the same. In this case, the ratio of a level D1 illustrated in FIG. 14 to a level D2 illustrated in FIG. 19 reflects the ratio of the average of the outputs of all the optical sensors WA at each point in time. Therefore, if the ratio of the level D1 to the level D2 is obtained in advance, the first-order approximate line 640 can be calculated based on the first-order approximate line 600 calculated at an earlier point in time and the ratio of the level D1 to the level D2 obtained in advance without calculating the first-order approximate line 640 from the output samples 651, 652, . . . 660. This also indicates that the individual addition/subtraction values to correct the output samples 651, 652, . . . 660 to be equivalent to the first-order approximate line 640 are obtained by applying the ratio of the level D1 to the level D2 to the individual addition/subtraction values to correct the output samples 521, 522, . . . 530 to be equivalent to the first-order approximate line 600. The ratio of the level D1 to the level D2 reflects the ratio of the average of the outputs of all the optical sensors WA at the point in time in FIG. 14 to the average of the outputs of all the optical sensors WA at the point in time in FIG. 19.

Thus, the relation between the outputs of the optical sensors WA at a certain point in time and the first-order approximate line (e.g., the relation between the output samples 521, 522, . . . 530 and the first-order approximate line 600) is used as a precondition. Under this precondition, the relation between the outputs of the optical sensors WA at a second point in time different from a first point in time and the first-order approximate line (e.g., the relation between the output samples 651, 652, . . . 660 and the first-order approximate line 640) can be calculated based on the ratio of the average of the outputs of the optical sensors WA at the first point in time to the average of the outputs of the optical sensors WA at the second point in time (e.g., the ratio of the average of the outputs of all the optical sensors WA at the point in time in FIG. 14 to the average of the outputs of all the optical sensors WA at the point in time in FIG. 19). In other words, the first-order approximate line and the correction value (calib) at the second point in time different from the first point in time can be calculated from the first-order approximate line and the correction value (calib) at the first point in time using the ratio between the averages.

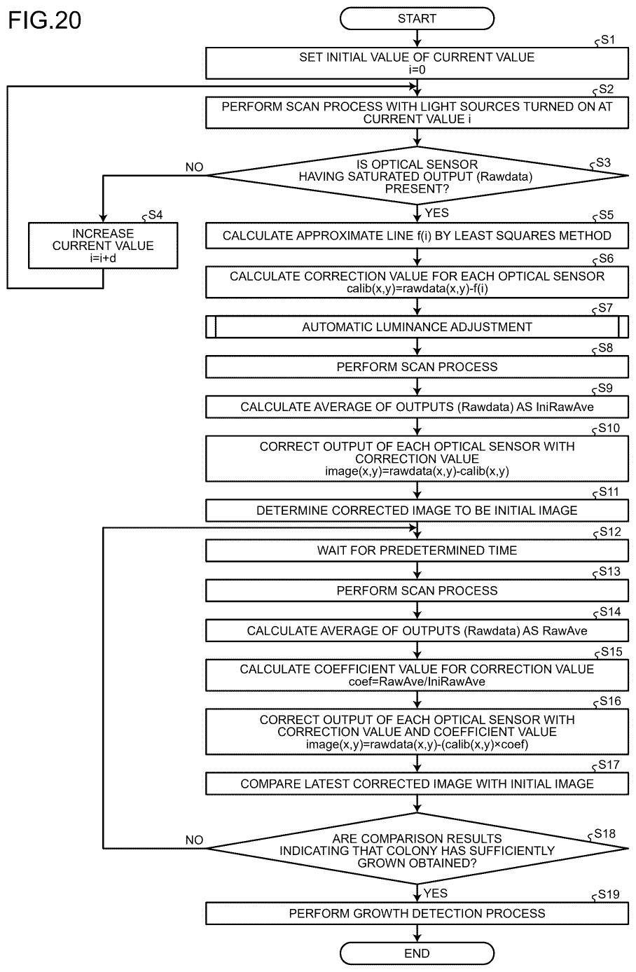

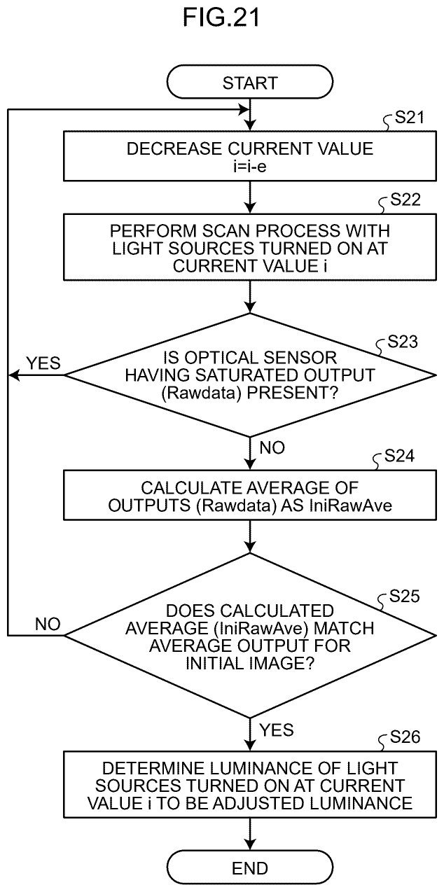

The control circuit 30, for example, performs the processing for calculating the first-order approximate line (e.g., the first-order approximate line 600), the processing for calculating the correction value (calib), and the arithmetic processing using the ratio between the averages (e.g., the ratio of the level D1 to the level D2) described with reference to FIGS. 12 to 19. However, the configuration is not limited thereto, and the host IC 70 may perform these processing. In the embodiment, the control circuit 30 performs these processing. The following describes the processing performed in the detection device 1 with reference to FIGS. 20 to 21.

FIG. 20 is a flowchart illustrating the processing performed in the detection device 1. In the description with reference to FIGS. 20 and 21, it is assumed that the object to be detected SUB is placed in the detection device 1 before the start of the processing.

First, an initial value of a current value (i) of a current supplied to turn on the light sources 22 is set (Step S1). While FIG. 20 illustrates a case where the initial value is 0, the initial value may be a value corresponding to the current value to turn on the light sources 22 at the lowest luminance. The setting of the current value (i) and the updating of the current value (i) at a later step are performed by the control circuit 30.

After the processing at Step S1, a scan process is performed to detect light from the light sources 22 supplied with a current of the current value (i) (Step S2). The scan process at Step S2 is a process to obtain the output group 590 described with reference to FIG. 12. In other words, the scan process is a process to obtain the outputs of all the optical sensors WA at each of a plurality of predetermined sampling amounts of light for each of the sampling amounts of light. The current of the current value (i) is supplied to the light sources 22 when the light sources 22 are lit at the maximum amount of light among the sampling amounts of light. When, among the sampling amounts of light, a sampling amount of light other than the maximum amount of light is incident on the optical sensors WA, the current supplied to the light sources 22 is smaller than the current value (i). The maximum amount of light of the sampling amounts of light is preferably the amount of light obtained when the light sources 22 are turned on at the predetermined maximum luminance.

The current value (i) is applied to each of the first light source 22R, the second light source 22G, and the third light source 22B. In the embodiment, it is assumed that white light is obtained when the first light source 22R, the second light source 22G, and the third light source 22B are simultaneously supplied with the same current value and turned on. The scan process performed as the processing at Step S2 and Steps S8, S22, and S13, which will be described later, includes a scan process under the condition that the first light source 22R is turned on and neither the second light source 22G nor the third light source 22B is turned on, a scan process under the condition that the second light source 22G is turned on and neither the first light source 22R nor the third light source 22B is turned on, and a scan process under the condition that the third light source 22B is turned on and neither the first light source 22R nor the second light source 22G is turned on.

After the processing at Step S2, it is determined whether the optical sensor WA having a saturated output (Rawdata) is present (Step S3). Specifically, the control circuit 30 checks whether there is the optical sensor WA that produces the output corresponding to the predetermined maximum value of the output of the optical sensor WA as the processing at Step S3. If there is the optical sensor WA that produces the output corresponding to the maximum value, it is determined that the optical sensor WA having a saturated output (Rawdata) is present.

If it is determined that the optical sensor WA having a saturated output (Rawdata) is not present at Step S3 (No at Step S3), the control circuit 30 increases the current value (i) (Step S4). Specifically, the control circuit 30 adds a predetermined addition/subtraction value (d) for the current value to i, where d is a positive value. After the processing at Step S4, the processing at Step S2 is performed again.

If it is determined that the optical sensor WA having a saturated output (Rawdata) is present at Step S3 (Yes at Step S3), the first-order approximate line 600 is calculated by the least squares method from the outputs of the optical sensors WA obtained in the scan process at Step S2 (Step S5).

After the processing at Step S5, the correction value for the output of each optical sensor WA is calculated (Step S6). As described above, the correction value (calib) for a certain optical sensor WA is a set of addition/subtraction values applied individually to each of the outputs of the optical sensor WA (e.g., the output samples 521, 522, . . . 530) corresponding to different amounts of light. At Step S6, the processing is performed to calculate the difference between the output of the optical sensor WA and the first-order approximate line 600 calculated at Step S5 for each of the sampling amounts of light applied at Step S2. In FIG. 20, “calib(x, y)=rawdata(x, y)−f(i)” is given as the expression for calculating the difference, wherein calib(x, y) is the correction value applied to the optical sensor WA positioned at the coordinates (x, y), rawdata (x, y) is the output of the optical sensor WA, and f(i) is the first-order approximate line 600. The processing at Step S6 is performed individually for each of the optical sensors WA. After the processing at Step S6, automatic luminance adjustment is performed (Step S7).

FIG. 21 is a flowchart illustrating processing of the automatic luminance adjustment. First, the control circuit 30 decreases the current value (i) (Step S21). Specifically, the control circuit 30 subtracts a predetermined subtraction value (e) for the current value from i, where e is a positive value.

After the processing at Step S21, a scan process is performed to detect light from the light sources 22 supplied with a current of the current value (i) (Step S22). Unlike the processing at Step S2, the processing at Step S22 is a scan process to simply detect light from the light sources 22 supplied with a current of the current value (i) without supplying a current smaller than the current value (i) to the light sources 22 for the output groups 590.

After the processing at Step S22, it is determined whether the optical sensor WA having a saturated output (Rawdata) is present (Step S23). The processing at Step S23 is the same as the processing at Step S3. If it is determined that the optical sensor WA having a saturated output (Rawdata) is present at Step S23 (Yes at Step S23), the processing at Step S21 is performed again.

By contrast, if it is determined that the optical sensor WA having a saturated output (Rawdata) is not present at Step S23 (No at Step S23), the control circuit 30 calculates the average of the outputs of all the optical sensors WA obtained at Step S22 and sets the calculated average as IniRawAve (Step S24).

After the processing at Step S24, the control circuit 30 determines whether the average (IniRawAve) calculated at Step S24 matches the average output for the initial image (Step S25). Specifically, the control circuit 30 determines whether outputs that fall within a predetermined output range of the optical sensors WA were obtained in the latest scan process at Step S22. The “outputs that fall within the predetermined output range of the optical sensors WA” means, for example, the outputs of the optical sensors WA substantially the same as in the case of the amount of light 690 (refer to “state example 1” in FIG. 18). The criterion for determining “whether the calculated average can be employed as the average output for the initial image” at Step S25 corresponds to the optical characteristics of the object to be detected SUB placed in the detection device 1 before the processing at Step S1 and the culture medium in the object to be detected SUB, and is not limited to “state example 1”.

If it is determined that the average (IniRawAve) does not match the average output for the initial image at Step S25 (No at Step S25), the processing at Step S21 is performed again. If it is determined that the average (IniRawAve) matches the average output for the initial image at Step S25 (Yes at Step S25), the control circuit 30 determines the luminance of the light sources 22 turned on at the latest current value (i) to be the adjusted luminance in the automatic luminance adjustment at Step S7 (Step S26), and terminates the automatic luminance adjustment.

After the automatic luminance adjustment at Step S7, a scan process is performed (Step S8) as illustrated in FIG. 20. After the processing at Step S8, the control circuit 30 calculates the average of the outputs of all the optical sensors WA obtained at Step S8 and sets the calculated average as IniRawAve (Step S9). The processing at Step S8 and the processing at Step S9 can be omitted. IniRawAve calculated at Step S9 and IniRawAve calculated at Step S24 are substantially the same. The outputs of the optical sensors WA obtained at Step S8 and the outputs of the optical sensors WA obtained at Step S22 are substantially the same.

Subsequently, the control circuit 30 corrects the outputs of the optical sensors WA obtained in the latest scan process with the correction value calculated at Step S6 (Step S10). In FIG. 20, the corrected output of each optical sensor WA is denoted as image(x, y) that satisfies image(x, y)=rawdata(x, y)−calib(x, y). In other words, the correction by the correction value is performed by subtracting the correction value (calib(x, y)) calculated individually for each optical sensor WA from the output (rawdata(x, y)) of the optical sensor WA. After the processing at Step S10, the control circuit 30 sets the corrected image as the initial image (Step S11), wherein the corrected image is the image composed of the set of the outputs of the optical sensors WA corrected by the processing at Step S10,.

After the processing at Step S11, the system control waits for a predetermined time (Step S12). The predetermined time is a time corresponding to the execution cycle of the scan process determined in advance for the purpose of monitoring the growth of the colony. The predetermined time is five minutes, for example, but is not limited thereto, and can be changed as appropriate.

After the processing at Step S12, a scan process is performed (Step S13). The scan process at Step S13 is the same scan process as that at Step S22 and Step S8. At the time of execution of the processing at Step S13, however, a time has elapsed since the time of acquisition of the initial image (the time of Step S11) after the processing at Step S12 has been performed one or more times.

After the processing at Step S13, the control circuit 30 calculates the average of the outputs of all the optical sensors WA obtained at Step S13 and sets the calculated average as RawAve (Step S14). After the processing at Step S14, the control circuit 30 calculates a coefficient value to be applied to the correction value (Step S15). In FIG. 20, the coefficient value is denoted as coef that satisfies coef=RawAve/IniRawAve. IniRawAve corresponds to the level D1 illustrated in FIG. 14, for example. RawAve corresponds to the level D2 illustrated in FIG. 19, for example. Therefore, the processing at Step S15 is an arithmetic operation based on the tendency of the change in the output of the optical sensor WA that may change according to the state of the culture medium in the object to be detected SUB described above.

As indicated by the calculation of the average determined to be IniRawAve by the processing at Step S24 and the processing at Step S9, and the calculation of the average determined to be RawAve by the processing at Step S14, the control circuit 30 according to the embodiment calculates the average of the outputs of the optical sensors WA included in the outputs of the sensor panel 10 obtained each time the acquisition process (processing at Step S22, processing at Step S8, and processing at Step S13) is performed. The outputs of the optical sensors WA obtained at Step S23 and Step S8 are the outputs of a plurality of optical sensors WA included in the outputs of the sensor panel 10 obtained in the acquisition process performed immediately after the calculation of the correction value (calib) (processing at Step S6). Therefore, the outputs of the optical sensors WA obtained at Step S22 and Step S8 correspond to first outputs. The outputs of the optical sensors WA obtained at Step S13 are the outputs of a plurality of optical sensors WA included in the outputs of the sensor panel 10 obtained in the acquisition process performed after the predetermined time has elapsed (processing at Step S12) one or more times after the first outputs described above are obtained. Therefore, the outputs of the optical sensors WA obtained at Step S13 corresponds to second outputs. The processing at Step S15 is processing for calculating the coefficient value (coef) corresponding to the ratio of the average (IniRawAve) of the first outputs described above to the average (RawAve) of the second outputs described above.

After the processing at Step S15, the control circuit 30 corrects the outputs of the optical sensors WA obtained in the latest scan process using the correction value calculated at Step S6 and the coefficient value obtained at Step S15 (Step S16). In FIG. 20, the corrected output of each optical sensor WA is denoted as image(x, y) that satisfies image(x, y)=rawdata(x, y)−(calib(x, y)×coef). In other words, the correction by the correction value is performed by subtracting the value obtained by multiplying the correction value (calib(x, y)) calculated individually for each optical sensor WA by the coefficient value (coef) obtained at Step S15 from the output (rawdata(x, y)) of the optical sensor WA. Thus, the individual correction value (calib(x, y)) to be applied to the second outputs described above is multiplied by the coefficient value (coef) at Step S16.

As in the processing at Step S10 and the processing at Step S16, the detection device according to the embodiment applies the individual correction values (calib(x, y)) to the outputs from the respective optical sensors WA included in the outputs of the sensor panel 10 obtained in the acquisition process (processing at Step S22, processing at Step S8, and processing at Step S13) performed after the calculation of the correction value (processing at Step S6). In other words, each individual correction value is applied to the output of the corresponding optical sensor.

After the processing at Step S16, the control circuit 30 determines the image composed of the set of the outputs of the optical sensors WA corrected by the processing at Step S16 to be the latest corrected image, and compares the latest corrected image with the initial image obtained at Step S11 (Step S17). The initial image obtained at Step S11 is an image corresponding to the “first image” described with reference to FIG. 8, for example. If the colony has sufficiently grown in the object to be detected SUB when the latest processing at Step S13 is performed to obtain the latest corrected image, the latest corrected image is an image corresponding to the “second image” described with reference to FIG. 8, for example.

The control circuit 30 determines whether the comparison results indicating that the colony has sufficiently grown are obtained by the processing at Step S17 (Step S18). Specifically, for example, if an area is generated that indicates that the colony has sufficiently grown, such as the differential areas 174, 175, and 176 in “difference” described with reference to FIG. 8, it is determined that the comparison results indicating that the colony has sufficiently grown are obtained; if not, it is determined that the comparison results indicating that the colony has sufficiently grown are not obtained.

If it is determined that the comparison results indicating that the colony has sufficiently grown are not obtained at Step S18 (No at Step S18), the processing at Step S12 is performed again. Thus, the detection device according to the embodiment may repeatedly perform the waiting for the predetermined time (Step S12) and the obtaining the outputs of the sensor panel 10 by the scan process (Step S13). If the acquisition of the initial image is defined as the starting point, the waiting for the predetermined time (Step S12) and the scan process (Step S13) are always performed one or more times. Therefore, the control circuit 30 performs the acquisition process each time the predetermined time elapses.

If it is determined that the comparison results indicating that the colony has sufficiently grown are obtained at Step S18 (Yes at Step S18), a growth detection process is performed (Step S19). Specifically, the host IC 70 transmits an electronic message to report that the colony has sufficiently expanded on the object to be detected SUB to a pre-registered contact address of an administrator of the detection system 100. Such an electronic message is electronic mail, for example, but is not limited thereto, and may be a message of another form or a voice signal that serves in the same way.

In the embodiment, when it is determined that the colony has been sufficiently cultured by at least one of the first light detection, the second light detection, and the third light detection, the growth detection process described above is performed. The conditions for performing the growth detection process may be appropriately modified as long as it can be determined that the colony has been sufficiently cultured.

As described above, according to the embodiment, the detection device 1 includes the sensor panel (such as the sensor panel 10) that has the detection area SA in which the optical sensors (such as the optical sensors WA) are two-dimensionally arranged, the light sources (such as the light sources 22) that emit light, the member (such as the member 60) on which the object to be detected (such as the object to be detected SUB) is to be placed so that the object to be detected is interposed between the detection area SA and the light sources, and the control circuit (such as the control circuit 30) that controls operations of the sensor panel and the light sources and performs the processing based on the outputs of the optical sensors. The object to be detected is provided with the culture medium in which the colony can be cultured. The control circuit performs an acquisition process to operate the light sources to generate the light traveling toward the sensor panel after the placement of the object to be detected, and acquire the outputs of the sensor panel corresponding to the light intensities detected by the optical sensors. The control circuit performs regression on the outputs of the sensor panel and calculates an approximate line (e.g., the first-order approximate line 600 illustrated in FIG. 12) indicating the relation between the amount of light emitted from the light source to the optical sensor and the output of the optical sensor. The control circuit calculates the difference between the output of the optical sensor and the approximate line individually for the output from each of the optical sensors, as a correction value (e.g., calib(x, y)). Each individual correction value is applied to the output of the corresponding optical sensor. Therefore, the influence of variations in the outputs from the optical sensors can be reduced.

The regression performed on the outputs of the sensor panel is linear regression using the least squares method, so that the detection device 1 can more efficiently calculate the parameters serving as the criterion for calculating the correction value to suppress the variations in the outputs of the optical sensors.

The control circuit operates the light sources (such as the light sources 22) to generate the light traveling toward the sensor panel (such as the sensor panel 10) after the placement of the object to be detected (such as the object to be detected SUB), and performs the acquisition process to acquire the outputs of the sensor panel corresponding to the light intensities detected by the optical sensors (such as the optical sensors WA) each time a predetermined time elapses, calculates the average (such as IniRawAve and RawAve) of the outputs of the optical sensors included in the outputs of the sensor panel obtained each time the acquisition process is performed, calculates a coefficient value corresponding to the ratio of the average of first outputs to the average of second outputs, and multiplies the individual correction value (such as calib(x, y)) applied to the second outputs by the coefficient value (such as coef). Thus, the detection device 1 can respond to changes in the outputs of the optical sensors corresponding to changes over time that may occur in the object to be detected using the coefficient value. Therefore, the detection relating to the object to be detected can be performed with higher accuracy. The first outputs are the outputs of the optical sensors included in the outputs of the sensor panel obtained in the acquisition process performed immediately after the calculation of the correction value. The second outputs are the outputs of the optical sensors included in the outputs of the sensor panel obtained in the acquisition process performed after the predetermined time has elapsed one or more times after the first outputs are obtained.

The optical member (such as the member 60) that limits the light emitted from the light sources (such as the light sources 22) and reaching the sensor panel is provided between the sensor panel (such as the sensor panel 10) and the object to be detected (such as the object to be detected SUB). With this configuration, the light emitted from the light sources and reaching the sensor panel can be easily limited to more preferable light in terms of the detection of the colony on the object to be detected.

The optical member (such as the member 60) includes any one of the plate-shaped louver, the cylindrical opening, and the microlens. With this configuration, the direction of the light emitted from the light sources (such as the light sources 22) and reaching the sensor panel (such as the sensor panel 10) can be more easily limited to a direction in which the light sources face the sensor panel (such as the third direction Dz).

The light source 22 illustrated in FIG. 9 has a configuration in which the longitudinal directions of the first light source 22R, the second light source 22G, and the third light source 22B are along the second direction Dy, and the first light source 22R, the second light source 22G, and the third light source 22B are arranged in this order from one side toward the other side in the first direction Dx. This configuration is, however, an exemplary form of the light source 22, which is not limited to this form. For example, the shape of the first light source 22R, the second light source 22G, and the third light source 22B in the light source 22 in plan view, and the positional relation among the first light source 22R, the second light source 22G, and the third light source 22B can be changed as appropriate. A single white light source may be provided instead of the first light source 22R, the second light source 22G, and the third light source 22B.

The switching elements 81 and 85 illustrated in FIG. 3 are each not limited to the configuration with a single switching element. For example, at least one of the switching element 81 and the switching element 85 may have what is called a double-gate configuration.

The object to be detected, such as the object to be detected SUB, is not limited to the Petri dish in which the culture medium is formed, and may have another configuration. The object to be detected may be, for example, a plate for suspension culture.

The arrangement of the optical sensors WA is not limited to a matrix having a row-column configuration along the first direction Dx and the second direction Dy. For example, the optical sensors WA arranged in the sensor rows adjacent in the second direction Dy need not both be located on a line along the second direction Dy. Specifically, the optical sensors WA may be arranged in what is called a staggered manner. From the viewpoint of using a wiring line for both the reset signal transmission line 5 and the scan line 6, the arrangement of the optical sensors WA in the first direction Dx is preferably such that the optical sensors WA are located on a line along the first direction Dx, but this arrangement is also not essential and can be changed as appropriate within a range of not impairing the functions of the optical sensors WA and the detection area SA. The arrangement of the light sources 22 in the light source panel 20 is also not limited to a matrix having a row-column configuration and can be any arrangement.

In the embodiment described above, the least squares method, which corresponds to linear regression, is employed as the “regression performed on the outputs of the sensor panel” for the calculation of the correction value (calib). The “regression performed on the outputs of the sensor panel” is not limited thereto and may be any of simple regression, multiple regression, and nonlinear regression. In other words, the approximate line is not limited to a first-order approximate line and may be other types of approximate lines, such as an approximate curve. That is, the specific method of “regression performed on the outputs of the sensor panel” simply needs to be a regression method that can calculate the parameters serving as the criterion for calculating the correction value to suppress the variations in the outputs of the optical sensor.

Other operational advantages accruing from the aspects described in the present embodiment that are obvious from the description herein, or that are conceivable as appropriate by those skilled in the art will naturally be understood as accruing from the present disclosure.

What is claimed is:

1. A detection device comprising:
a sensor panel having a detection area in which a plurality of optical sensors are two-dimensionally arranged;
a light source configured to emit light;
a member on which an object to be detected is to be placed so that the object to be detected is interposed between the detection area and the light source; and
a control circuit configured to control an operation of the sensor panel and the light source and perform processing based on outputs of the optical sensors, wherein
the object to be detected is provided with a culture medium capable of culturing a colony,
the control circuit is configured to:
perform an acquisition process to operate the light source to generate light traveling toward the sensor panel after placement of the object to be detected, and acquire outputs of the sensor panel corresponding to intensities of light detected by the optical sensors;
perform regression on the outputs of the sensor panel to calculate an approximate line indicating a relation between the amount of light emitted from the light source to each of the optical sensors and the output of the optical sensor; and
calculate a difference between the output of the optical sensor and the approximate line individually for each of the optical sensors, as a correction value, and
the correction value calculated individually is applied to the output of the corresponding optical sensor.

2. The detection device according to claim 1, wherein the regression is linear regression using the least squares method.

3. The detection device according to claim 2, wherein
the control circuit is configured to:
perform the acquisition process each time a predetermined time elapses;
calculate an average of the outputs of the optical sensors included in the outputs of the sensor panel obtained each time the acquisition process is performed; and
calculate a coefficient value corresponding to the ratio of an average of first outputs to an average of second outputs and multiply the correction value calculated individually and applied to the second outputs by the coefficient value,
the first outputs are the outputs of the optical sensors included in the outputs of the sensor panel obtained in the acquisition process performed immediately after calculating the correction value, and
the second outputs are the outputs of the optical sensors included in the outputs of the sensor panel obtained in the acquisition process performed after the predetermined time has elapsed one or more times after the first outputs are obtained.

4. The detection device according to claim 1, wherein an optical member configured to limit the light emitted from the light source and reaching the sensor panel is provided between the sensor panel and the object to be detected.

5. The detection device according to claim 4, wherein the optical member comprises any one of a plate-shaped louver, a cylindrical opening, and a microlens.
